(19) United States
(12) Patent Application Publication
(10) Pub. No.: US 2015/0240170 A1
(43) Pub. Date: Aug. 27, 2015

(54) METHOD AND APPARATUS FOR TREATING WASTE MATERIAL AND A PRODUCT GAS

(71) Applicant: TEKNOLOGIAN TUTKIMUSKESKUS VTT OY, FI-02150 Espoo (FI)

(72) Inventors: Esa Kurkela, Espoo (FI); Matti Nieminen, Espoo (FI)

(21) Appl. No.: 14/439,937

(22) PCT Filed: Oct. 9, 2013
(86) PCT No.: PCT/FI2013/050977

§ 371 Date: Apr. 30, 2015

(30) Foreign Application Priority Data
Oct. 31, 2012 (FI) 20126130

(51) Int. Cl. C10J 3/52; G21F 9/00; C10J 3/72; C10L 3/00; C10J 3/48; C10J 3/46; G21F 9/30; G21F 9/02

(52) U.S. Cl. CPC C10J 3/523; G21F 9/30; G21F 9/001; G21F 9/02; C10L 3/00; C10J 3/482; C10J 3/463; C10J 3/72; C10J 3/723; C10J 2300/0946; C10J 2300/1628; C10J 2300/1606; C10J 2300/1615; C10J 2300/1246; C10J 2300/1618; C10L 2200/0461; C10L 2290/02; C10L 2290/04; C10L 2290/06; C10L 2290/545; C10L 2290/58

(57) ABSTRACT

A method and apparatus for treating waste material having organic components and radioactive agents. The method including the steps of gasifying the waste material at temperature between 600-950° C. in a reactor to form a gaseous material. The gaseous material is cooled to a temperature between 300-500° C., after the cooling the solid fraction including the radioactive agents are removed.

### FIELD OF THE INVENTION

The invention relates to a method defined in the preamble of claim 1 and an apparatus defined in the preamble of claim 9 for treating waste material including organic components and radioactive agents. Further, the invention relates to a product gas defined in the preamble of claim 16.

### BACKGROUND OF THE INVENTION

It is known from the prior art that radioactively contaminated waste is difficult to treat. Further, disposal of the radioactively contaminated waste is costly.

### OBJECTIVE OF THE INVENTION

The objective of the invention is to disclose a new type method and apparatus for treating waste material including organic components and radioactive agents. Further, the objective of the invention is to disclose a method and apparatus for treating contaminated waste material into environmentally safe form. Further, the objective of the invention is to decrease amount of waste material. Further, the objective of the invention is to produce a new gaseous product.

### SUMMARY OF THE INVENTION

The method and apparatus according to the invention is characterized by what has been presented in the claims.

The invention is based on a method for treating waste material including organic components and radioactive agents. According to the invention, the method comprises steps in order to form a treated gaseous material: the waste material including organic components and radioactive agents which are low-level and/or medium-level radioactive agents is gasified at temperature between 600-950° C. in a reactor to form a gaseous material; the gaseous material is cooled by water quenching so that temperature is between 300-500° C. after the cooling; and solid fraction including radioactive agents is removed from the gaseous material in a gas cleaning step.

Further, the invention is based on an apparatus for treating waste material including organic components and radioactive agents. According to the invention, the apparatus for forming a treated gaseous material comprises: a reactor in which the waste material including organic components and radioactive agents which are low-level and/or medium-level radioactive agents is gasified at temperature between 600-950° C. to form a gaseous material; a cooling step comprising at least one water quenching step in which the gaseous material is cooled so that temperature is between 300-500° C. after the cooling; and a gas cleaning device in which solid fraction including radioactive agents is removed from the gaseous material.

Further, the invention is based on a product gas. According to the invention, the product gas contains treated gaseous material which has been formed from waste material including organic components and radioactive agents which are low-level and/or medium-level radioactive agents so that the waste material including organic components and radioactive agents has been gasified at temperature between 600-950° C. in a reactor to form a gaseous material, the gaseous material has been cooled by water quenching so that temperature is between 300-500° C. after the cooling, and solid fraction including radioactive agents has been removed from the gaseous material in a gas cleaning step.

Preferably, the gaseous material is combustible.

In this context, the radioactive agents refer to any radioactive material, compounds and chemical elements and their derivates. In this context, radioactive agents are low-level and/or medium-level.

In this context, the waste material including organic components and radioactive agents means any material which includes organic and radioactive components. The waste material including organic components and radioactive agents may be selected from the group containing resins, such as resins from nuclear power plant, clothes, such as industrial protective clothing and protective clothing, contaminated wood, contaminated vegetable matter such as corn, straw and hay.

Any reactor known per se can be used in the gasification. Preferably, the reactor can be a fluidized bed reactor, bubbling or circulating fluidized bed reactor or the like. In one embodiment the reactor is fluidized bed reactor. In the fluidized bed reactor hot spots don't form in the reactor bed. Sand, aluminium oxide or other suitable bed material may be used as the bed material.

In one embodiment radioactive agents and other metals may partly vaporize during the gasification. When the gaseous material is cooled so the radioactive agents and other metals which have vaporized during the gasification are condensed and changed back solid form.

It is important that temperature can be controlled in the gasification. It is important for the invention that organic and radioactive agents can be removed. In the gasification the radioactive agents and other metals may partly vaporize. However, because low temperature is used in the gasification so vaporization of metals can be minimized. In the cooling the radioactive agents and other metals are condensed and changed back solid form.

In one embodiment, the waste material including organic components and radioactive agents is gasified at temperature between 600-900° C. in a reactor to form a gaseous material. In one embodiment, the waste material is gasified at temperature between 700-950° C., and in one embodiment between 700-900° C. In one embodiment, the waste material is gasified at temperature between 750-950° C., and in one embodiment between 750-900° C.

In one embodiment, the waste material including organic components and radioactive agents is gasified by air. In a preferred embodiment air ratio is below 1, preferably below 0.7, more preferable below 0.5 and most preferable below 0.4.

In one embodiment, the waste material including organic components and radioactive agents may be dewatered before the gasification. In one embodiment water is removed mechanically from the waste material including organic components and radioactive agents. In one embodiment the waste material including organic components and radioactive agents is dried by the drying device.

In one embodiment the other organic material is added into the waste material including organic components and radioactive agents before the gasification. The other organic material may be selected from the group containing oil, plastic, polymers or the like. It is important that ash content of the other organic material is low.

In one embodiment, the gaseous material is cooled so that temperature is between 350-450° C. after the cooling.

Preferably, the gaseous material is cooled by water quenching. The apparatus comprises water quenching step for cooling the gaseous material. The water quenching step may include one or more devices suitable for carrying out water quenching.

In one embodiment, the gaseous material is cooled by heat exchanger. In one embodiment, the apparatus comprises at least one heat exchanger for cooling the gaseous material.

In one embodiment, the gaseous material is filtered in the gas cleaning step in order to remove solid fraction including radioactive agents. The apparatus comprises at least one filtration device. In one embodiment, the filtration is carried out at temperatures between 300-500° C. It is important that the temperature is not too high because, for example, at temperature 600° C. metals may traverse the filtration device. In one embodiment, the filtration device is hot gas filter. In one embodiment the filtration device includes at least one or more ceramic filter. In one embodiment the filtration device includes at least one or more metal filter, preferably sintered metal filter.

In one embodiment, the treated gaseous material is burnt after the removing of the solid fraction including radioactive agents. Preferably, the treated gaseous material is burnt at temperature over 1000° C. In one embodiment, the apparatus comprises a combustion reactor in which the treated gaseous material is burnt after the removing of the solid fraction including radioactive agents.

In one embodiment, the treated gaseous material or the gas flow of the combustion is post-treated by a gas scrubbing. Preferably, sulphur is removed during the gas scrubbing. In one embodiment, the treated gaseous material may be post-treated by the gas scrubbing directly after the removing of the solid fraction including radioactive agents or alternatively the gas flow may be post-treated by the gas scrubbing after the combustion step which has been done after the removing of the solid fraction including radioactive agents. In one embodiment, the apparatus comprises a gas scrubbing device for post-treating.

In one embodiment sulphur may be removed in connection with the combustion step of the treated gaseous material. However, the sulphur removing is easier to carry out in connection with the gas scrubbing.

In one embodiment, the product gas contains 70-100 vol-% treated gaseous material.

In one embodiment, the product gas or the treated gaseous material is used and utilized as a fuel of energy production process. In one embodiment, the product gas or the treated gaseous material is used as a fuel as such or after the gas scrubbing.

The invention provides the advantage that the contaminated waste material can be purified. Thanks to the invention, radioactive fraction can be concentrated and amount of the waste material, and volume of the waste material, can be decreased. By means of the invention even over 90% volume reduction may be achieved in the amount of the radioactive disposal. The formed radioactive fraction can be disposed as any radioactive waste. Further, by means of the invention gaseous fuel can be produced for energy production process.

The method and apparatus of the invention offers a possibility to treat contaminated waste material cost-effectively and energy-effectively. The present invention provides an industrially applicable, simple and affordable way of producing treated gaseous material. The method and apparatus of the present invention is easy and simple to realize as a production process.

### LIST OF FIGURES

In the following section, the invention will be described with the aid of detailed exemplary embodiments, referring to the accompanying figure wherein

FIG. 1 presents one embodiment of the apparatus according to the invention, and

FIG. 2 presents another embodiment of the apparatus according to the invention.

### DETAILED DESCRIPTION OF THE INVENTION

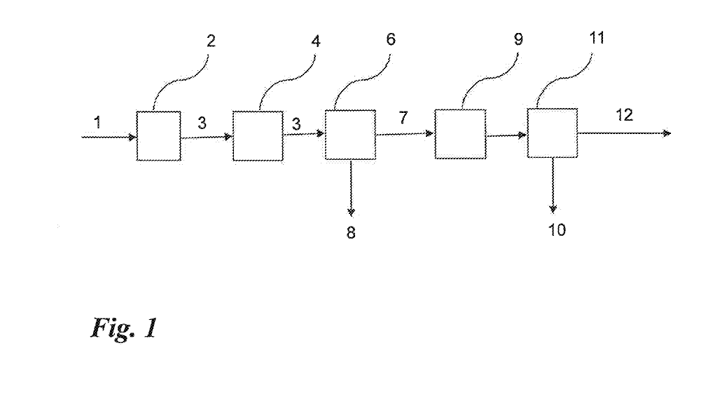

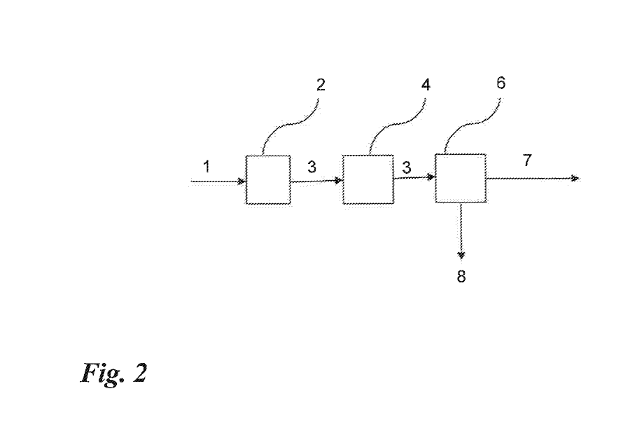

FIGS. 1 and 2 present the apparatuses according to the invention for treating waste material including organic components and radioactive agents.

### Example 1

The apparatus of FIG. 1 comprises a fluidized bed reactor 2 in which the waste resin material 1 including organic components and radioactive agents is gasified at temperature between 750-950° C. to form a gaseous material 3, a water quenching step 4 in which the gaseous material is cooled so that temperature is between 350-450° C. after the cooling, and a metal filtration device 6 in which solid fraction 8 including radioactive agents is removed from the gaseous material 3. The waste resin material 1 may be dewatered before the gasification.

The apparatus comprises a combustion reactor 9 in which the treated gaseous material 7 is burnt at temperature over 1000° C. after the removing of the solid fraction 8 including radioactive agents. Further, the apparatus comprises a gas scrubbing device 11 for post-treating the gas flow after the combustion of the treated gaseous material. Sulphur 10 is removed from the gas flow during the gas scrubbing 11 wherein clean exhaust gas 12 is achieved.

### Example 2

The apparatus of FIG. 2 comprises a fluidized bed reactor 2 in which the waste material 1 including organic components and radioactive agents is gasified at temperature between 600-950° C. to form a gaseous material 3, a heat exchanger 4 in which the gaseous material is cooled so that temperature is between 300-500° C. after the cooling, and a metal filtration device 6 in which solid fraction 8 including radioactive agents is removed from the gaseous material 3. In this example the waste material 1 comprises contaminated clothes, wood and vegetable matters.

The treated gaseous material 7 is used directly as a fuel of energy production process. The treated gaseous material may be post-treated by gas scrubbing before the using as a fuel. Alternatively, the treated gaseous material may be burnt in a combustion reactor and/or post-treated by a gas scrubbing.

The devices used in this invention are known per se in the art, and therefore they are not described in any more detail in this context.

The method and apparatus according to the invention is suitable in different embodiments for treating different kinds of waste material.

The invention is not limited merely to the examples referred to above; instead many variations are possible within the scope of the inventive idea defined by the claims.

1. A method for treating waste material including organic components and radioactive agents, wherein that the method comprising steps the waste material including organic components and radioactive agents which are low-level and/or medium-level radioactive agents is gasified at temperature between 600-950° C. in a reactor to form a gaseous material,
the gaseous material is cooled by water quenching so that temperature is between 300-500° C. after the cooling, and
solid fraction including radioactive agents is removed from the gaseous material in a gas cleaning step,
in order to form a treated gaseous material.

2. The method according to claim 1, wherein the gaseous material is combustible.

3. The method according to claim 1, wherein the gaseous material is cooled by heat exchanger.

4. The method according to claim 1, wherein the gaseous material is filtered in the gas cleaning step.

5. The method according to claim 4, wherein the filtration is carried out at temperatures between 300-500° C.

6. The method according to claim 1, wherein the treated gaseous material is burnt after the removing of the solid fraction including radioactive agents.

7. The method according to claim 1, wherein the treated gaseous material is post-treated by a gas scrubbing.

8. The method according to claim 1, wherein other organic material is added into the waste material including organic components and radioactive agents before the gasification.

9. An apparatus for treating waste material including organic components and radioactive agents, wherein the apparatus for forming a treated gaseous material comprises
a reactor in which the waste material including organic components and radioactive agents which are low-level and/or medium-level radioactive agents is gasified at temperature between 600-950° C. to form a gaseous material,
a cooling step comprising at least one water quenching step in which the gaseous material is cooled so that temperature is between 300-500° C. after the cooling, and
a gas cleaning device in which solid fraction including radioactive agents is removed from the gaseous material.

10. The apparatus according to claim 9, wherein the reactor is fluidized bed reactor.

11. The apparatus according to claim 9, wherein the apparatus comprises at least one heat exchanger for cooling the gaseous material.

12. The apparatus according to claim 9, wherein the apparatus comprises at least one filtration device.

13. The apparatus according to claim 12, wherein the filtration device is hot gas filter.

14. The apparatus according to claim 9, in that the apparatus comprises a combustion reactor in which the treated gaseous material is burnt after the removing of the solid fraction including radioactive agents.

15. The apparatus according to claim 9, wherein the apparatus comprises a gas scrubbing device for post-treating.

16. A product gas, wherein the product gas contains treated gaseous material which has been formed from waste material including organic components and radioactive agents which are low-level and/or medium-level radioactive agents so that the waste material has been gasified at temperature between 600-950° C. in a reactor to form a gaseous material, the gaseous material has been cooled by water quenching so that temperature is between 300-500° C. after the cooling, and solid fraction including radioactive agents has been removed from the gaseous material in a gas cleaning step.

17. The product gas according to claim 16, wherein the product gas contains 70-100 vol-% treated gaseous material.
